(19) United States
(12) Patent Application Publication
(10) Pub. No.: US 2007/0180110 A1
(43) Pub. Date: Aug. 2, 2007

(54) System and method for retaining information in a data management system

(75) Inventor: Bhasker Gopal, Koramangala Layout (IN)

Correspondence Address: PETER VOGEL;GE HEALTHCARE, 3000 N. GRANDVIEW BLVD., SN-477, WAUKESHA, WI, 53188, US

(73) Assignee: GE Medical Systems Information Technologies, Inc., Milwaukee, WI (US)

(21) Appl. No.: 11/342,055

(22) Filed: Jan. 27, 2006

(51) Int. Cl. G06F 15/173

(52) U.S. Cl. 709/225

(57) ABSTRACT

A system for retaining information in a data management system in which a memory manger is associated with a server, an interface is provided for controlling access to the memory manager, and one or more application components are adapted for implementing the interface. A method for retaining information in a data management system in which information is stored and retrieved from an external database into a memory associated with a server and access to the memory is enabled through an interface implemented by one or more application components. A machine-readable storage medium and machine readable code for implementing the same.

### FIELD OF INVENTION

In general, the inventive arrangements relate to systems and methods for retaining information, and, more specifically, to systems and methods for retaining information in a data management system in the event of a service interruption thereto.

### BACKGROUND OF INVENTION

Many data management systems are implemented as a single centralized application, which users then access via the world wide web. Advantageously, this implementation minimizes a burdensome need to provide individualized application service, maintenance, and up-grading at local levels. If, however, an application server, web server, or the like associated with a centralized application needs to be re-started for some reason, then it is likely that at least some of its users may endure information and data loss or session termination, which are undesirable, inconvenient, and commonly require users to re-log into the application in order to continue use.

Few, if any, satisfactory solutions exist. For example, U.S. Pat. App. No. 2004/0193574 to Suzuki discloses an application server that includes “a cache memory that stores in a correlated form a retrieval condition and a retrieval result, an update condition setting unit that sets a cache update condition that indicates when the cache memory is to be updated, and an update processing unit that reads the retrieval condition from the cache memory upon fulfillment of the cache update condition, retrieves data as the retrieval result from the database using the retrieval condition, and updates the retrieval result in the cache memory corresponding to the retrieval condition.” Accordingly, most prior art solutions are limited to storing only database information, and they are commonly limited to use in only customized data management systems.

Thus, there exists a need for users to be able to maintain user sessions and prevent information and data loss or session termination during service interruptions to a data management system, particularly without requiring the users to re-log into the interrupted applications. Preferably, a desired solution should be universally applicable to a wide variety of data management systems and not be limited to only database information storage systems.

### SUMMARY OF INVENTION

In one embodiment, a system for retaining information in a data management system comprises a memory manager associated with a server, an interface for controlling access to the memory manager, and one or more application components adapted for implementing the interface and configured as a framework for computer-implementation into a data management system.

In another embodiment, a method for retaining information in a data management system comprises storing and retrieving information from an external database into a memory associated with a server and enabling access to the memory through an interface implemented by one or more application components.

In yet another embodiment, a machine-readable storage medium contains machine-readable code for instructing a machine to store and retrieve information from an external database into a memory associated with a server and enable access to the memory through an interface implemented by one or more application components.

In still another embodiment, machine-readable code stored on a machine-readable storage medium comprises code for storing and retrieving information from an external database into a memory associated with a server and code for enabling access to the memory through an interface implemented by one or more application components.

### BRIEF DESCRIPTION OF THE SEVERAL VIEWS OF THE DRAWINGS

A clear conception of the advantages and features constituting inventive arrangements, and of various construction and operational aspects of typical mechanisms provided by such arrangements, are readily apparent by referring to the following exemplary, representative, and non-limiting illustrations, which form an integral part of this specification, in which like numerals generally designate the same elements in the several views, and in which:

FIG. 1 depicts high-level sequential data paths in a typical data management system; and

FIG. 2 depicts a preferred framework for retaining information across an application server in a data management system in the event of a service interruption.

### DETAILED DESCRIPTION OF PREFERRED EMBODIMENTS

Various embodiments of the inventive arrangements provide a system, method, medium, and code for retaining information across an application server in a data management system, such as, for example, a clinical data management system. However, the inventive arrangements are not limited in this regard, and they may also be implemented in connection with other data management systems, such as, for example, banking, insurance, and other data management systems.

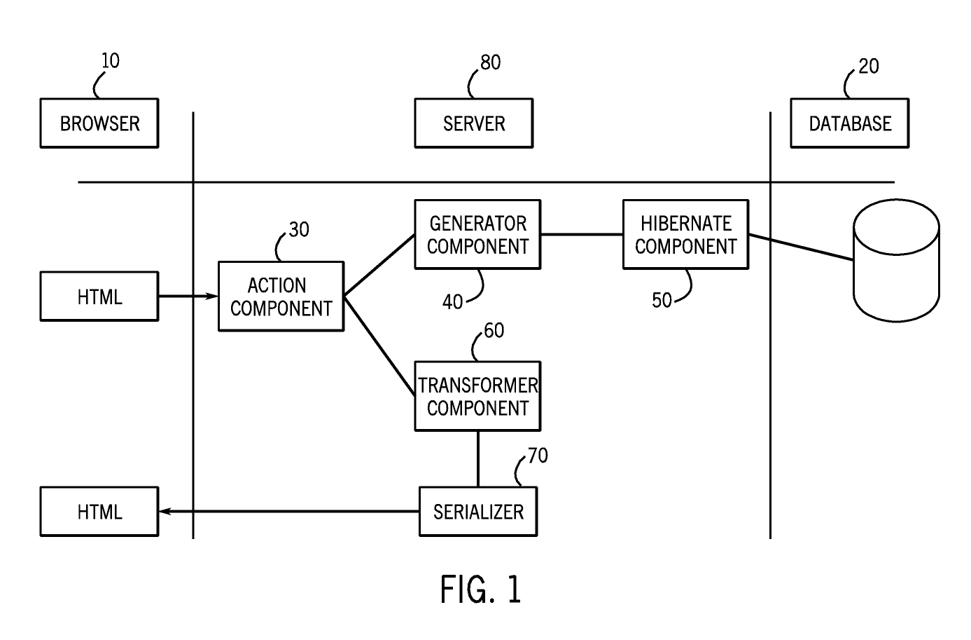

Referring now to FIG. 1, an application server 80 is connected to a web browser 10 at a front end and to a database 20 at a back end, by which HTML (i.e., “HyperText Mark-up Language”) requests from users' browsers 10 are directed to, and received at, an action component 30 that is associated with the application server 80.

This action component 30 is a functional gateway for the application server 80, and it verifies certain parameters from the various users. For example, if the action component 30 grants a user access to the application server 80, then the user's commands are communicated from the action component 30 to a generator component 40, which is in operative communication with the action component 30, along with other user provided information or data or requests, typically via XML (i.e., “Extensible Markup Language”) events. The generator component 40 is, in turn, in operative communication with a hibernate component 50, which is in operative communication with the database 20 for interaction therewith.

Commonly, the action component 30 is also in operative communication with a transfer component 60, which is in operative communication with a serializer 70 that returns communications back to users' browsers 10. Commonly, the transformer component 60 translates the XML data into XSL (i.e., “Extensible Style Language”) data, and the serializer 70 serializes the XSL data into XHTML (i.e., “Extensible HyperText Mark-up Language”) data, which is received and processed by the users' browsers 10, all by techniques known in the art. Accordingly, each of the action component 30, generator component 40, hibernate component 50, transformer component 60, and serializer 70 are associated with the application server 80.

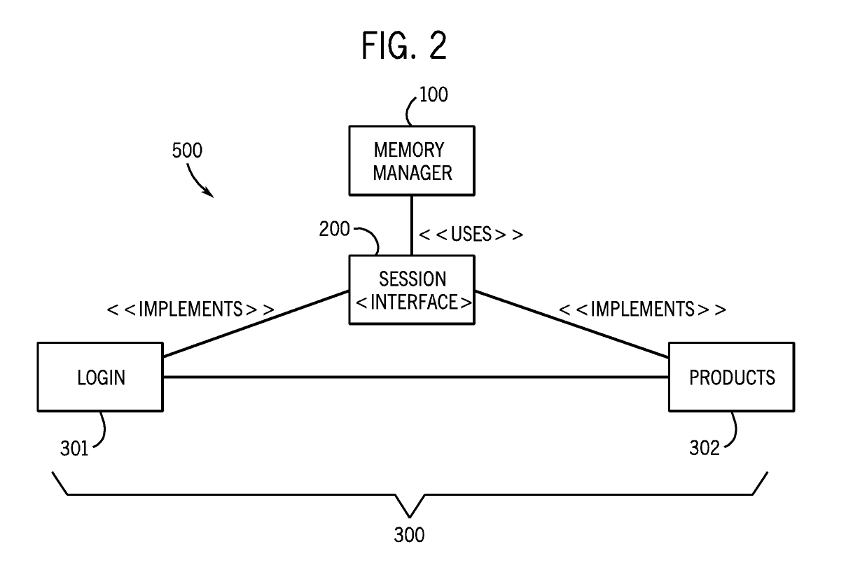

Referring now to FIG. 2, a memory manager 100 is configured for managing a memory (not illustrated in FIG. 2) associated with the application server 80 of FIG. 1. Preferably, it handles session information, including storing and receiving session information from the memory. In addition, an interface 200 is in operative communication with the memory manager 100 and is used to control users' access to the memory. In addition, one or more application components 300 are also preferably configured for implementing the interface 200. Thus, the memory manager 100, interface 200, and application components 300 are preferably configured as a software framework 500 for implementation into a desired data management system. Preferably, this software framework 500 is implemented as a part of the action component 30 of FIG. 1.

In a preferred embodiment, the interface 200 allows users to access implementation details existing in the memory manager 100. For example, preferred application components 300 include a login component 301 (Java class) and a product component 302 (Java class) that implement the interface 200, thus providing the software framework 500 for the specific computer implementation on a particular data management system. In various preferred embodiments, the implementation may be specific to handling clinical data, banking data, insurance data, or the like.

In a preferred embodiment, the memory manager 100 is the core class in Java and contains control logic for sending and receiving information from the memory. For example, this control logic preferably includes implementation details and methods by which applications can add or remove information to and from the memory. Now then, in the event of a service interruption to an application server 80, such as a system crash, which often causes information and data loss or session termination, the memory manager 100 prevents the loss of this information and data received from the users and preferably prevents session termination.

In one preferred embodiment, the memory associated with the application server 80 may include an in-line temporary memory. In another preferred embodiment, the memory may include an in-line permanent memory. As a result, the memory can be configured to store pertinent information, such as file format information, user information, product information, session information, access information, etc. This enables users to continue a computer session seamlessly in the event there is a service interruption in the data management system. In other words, once a user establishes a session with an application server 80, then the user may continue that session without being effected by a subsequent, and likely unanticipated, re-starting of the application server 80. For example, after a user establishes a session with an application server 80, the login component 301 maintains the user's session information in the interface 200 and the product component 302 maintains its product information in the interface 200. Then, if a user wants to view, for example, a list of products from the product component 302 after a time when the application server 80 has been re-started, the user may do so without having to re-log back into the application server 80 again. So, if a user does not close the user's browser 10, then the user can maintain the user's session, for hours, days, weeks, or even longer, without re-logging into the application server 80 even if the application server 80 has been re-started.

Notably, these embodiments are not limited to specific application servers 80, and they may work across all application servers 80. With suitable modifications, they can also be implemented in connection with various web servers as well.

In another preferred embodiment, a method for retaining information in a data management system comprises storing and retrieving information from the external database 20 into the memory associated with the application server 80 and enabling user access to the memory through the interface 200 implemented by the one or more application components 300. Preferably, the memory manager 100 stores and retrieves information from the memory. Preferably, the interface 200 holds the memory manager 100 instance and forms the user access channel for classes such as the login component 301 and product component 302.

For example, when a user logs into an application, the user related to the memory manager 100 stores information at the login component 301 and session information in the memory. If the user wishes to view, for example, a list of products from a company, then the product component 302 is invoked.

As a result, users can continue to work seamlessly, without being affected by re-starting an application server 80. Thus, users can log into an application once and then maintain a seamless use state for an extended period of time, such as, for example, several hours, days, weeks, or even longer, without needing to re-log into the application, provided the user has not closed their web browser.

The inventive arrangements can be realized in hardware, software, firmware, or a combination thereof. A visualization tool according to the inventive arrangements can be realized in a centralized fashion in one computer system or in a distributed fashion, in which different elements are spread across several interconnected computer systems. Any kind of computer system—or other apparatus adapted for carrying out the methods described herein—is suitable. A typical combination of hardware, software, and firmware could be a general purpose computer system with a computer program that, when being loaded and executed by known techniques, controls the computer system such that it carries out the methods described herein. The inventive arrangements can also be embedded in a computer program product, which comprises all the features enabling the implementation of the methods described herein, and which—when loaded into or onto a computer system—is able to carry out or execute these methods.

Accordingly, a machine-readable storage medium containing machine-readable code for instructing a machine to operate in a specified fashion is contemplated, as is the machine readable-code that is stored on the machine-readable storage medium. In a preferred embodiment, this machine is a computer, the machine-readable storage medium is a computer-readable storage medium and the machine-readable code is computer-readable code.

In this context, machine and computer-readable storage medium and machine and computer-readable code mean any expression, in any language, code, or notation, of a set of instructions or commands that are intended to or do cause a system having an information processing capability to perform a particular function, either directly or indirectly, or after either or both of the following: i) conversion to another language, code, or notation, and ii) reproduction in a different material form. This is one aspect of the technical effects of the inventive arrangements.

It should be readily apparent that this specification describes exemplary, representative, and non-limiting embodiments of the inventive arrangements. Accordingly, the scope of the inventive arrangements are not limited to any of these embodiments. Rather, various details and features of the embodiments were disclosed as required. Thus, many changes and modifications—as readily apparent to those skilled in the art—are within the scope of the inventive arrangements without departing from the spirit hereof, and the inventive arrangements include the same. Accordingly, to apprise the public of the scope and spirit of the inventive arrangements, the following claims are made:

What is claimed is:

1. A system for retaining information in a data management system, comprising:
(i) a memory manager associated with a server;
(ii) an interface for controlling access to the memory manager; and
(iii) one or more application components adapted for implementing the interface and configured as a framework for computer-implementation into a data management system.

2. The system of claim 1, wherein the memory manager is independent of an external database.

3. The system of claim 1, wherein the memory manager is an in-line memory.

4. The system of claim 3, wherein the in-line memory is temporary.

5. The system of claim 3, wherein the in-line memory is permanent.

6. The system of claim 1, wherein the one or more application components include at least one of a login component and a product component.

7. The system of claim 1, wherein the memory manager is configured for storing at least one of file format information, user information, product information, session information, and access information.

8. The system of claim 7, wherein the data management system is configured for handling at least one of clinical data, banking data, and insurance data.

9. The system of claim 1, wherein the server comprises at least one of an application server and web server.

10. A method for retaining information in a data management system, comprising:
(i) storing and retrieving information from an external database into a memory associated with a server, and
(ii) enabling access to the memory through an interface implemented by one or more application components.

11. The method of claim 10, wherein the memory comprises an in-line memory.

12. The method of claim 11, wherein the in-line memory is temporary.

13. The method of claim 1 1, wherein the in-line memory is permanent.

14. The method of claim 10, wherein the one or more application components include at least one of a login component and a product component.

15. The method of claim 1 0, wherein the information includes at least one of file format information, user information, product information, session information, and access information.

16. The method of claim 15, wherein the data management system is configured for handling at least one of clinical data, banking data, and insurance data.

17. The method of claim 10, wherein the server comprises at least one of an application server and web server.

18. A machine-readable storage medium containing machine-readable code for instructing a machine to operate as follows:
(i) storing and retrieving information from an external database into a memory associated with a server, and
(ii) enabling access to the memory through an interface implemented by one or more application components.

19. The machine-readable storage medium of claim 18, wherein the machine is a computer.

20. Machine-readable code stored on a machine-readable storage medium, comprising:
(i) code for storing and retrieving information from an external database into a memory associated with a server, and
(ii) code for enabling access to the memory through an interface implemented by one or more application components.
